(19) United States
(12) Patent Application Publication
(10) Pub. No.: US 2002/0065678 A1
(43) Pub. Date: May 30, 2002

(54) iSelect video

(76) Inventors: Steven Peliotis, Denver, CO (US); Steven O. Markel, Highlands Ranch, CO (US); Ian Zenoni, Highlands Ranch, CO (US); Thomas Lemmons, Evergreen, CO (US); Thomas Huber, Parker, CO (US)

Correspondence Address: The Law Offices of William W. Cochran LLC, Suite 230, 3555 Stanford Road, Fort Collins, CO, 80525, US

(21) Appl. No.: 09/933,928

(22) Filed: Aug. 21, 2001

Related U.S. Application Data
(60) Provisional application No. 60/227,890, filed on Aug. 25, 2000.
(60) Provisional application No. 60/227,916, filed on Aug. 25, 2000.

(51) Int. Cl. G06F 17/60

(52) U.S. Cl. 705/1

(57) ABSTRACT

Disclosed is a system that allows a video program to be broken up into video segments using markers that mark the beginning/end of each segment. Each video segment is then associated with a tag that describes the content and other information such as rating information relating to the subject matter of the video segment. Video segments can then be selected or excluded during either real time or nearly real time broadcast or on delayed broadcast to exclude the viewing of certain video clips based on user preferences or to allow the viewing of only certain chosen subject matter in accordance with user preferences.

### CROSS-REFERENCE TO RELATED APPLICATIONS

The present invention is based upon and claims priority from U.S. Provisional Application serial No. 60/227,890, filed Aug. 25, 2000 entitled “iSelect Video” by Steven Peliotis, and U.S. Provisional Application serial No. 60/227,916, filed Aug. 25, 2000 entitled “aPersonalized Remote Control” by Thomas Huber.

### BACKGROUND OF THE INVENTION

A. Field of Invention

The present invention generally pertains to video broadcast and more specifically, methods of automatically selecting or restricting various types of video broadcast.

B. Description of the Background

Often, news broadcasts may include news stories that the viewer may not want to see. Similarly, other types of video may include adult programming, violence, and other types of content that is not desired to be viewed by the viewer. On the other hand, the viewer may wish to focus on certain news broadcasts or other video content relating to specific subjects. For example, a viewer may wish to select video segments from news broadcasts relating to financial news on particular stocks that are held by the viewer. Currently, viewers are compelled to accept whatever news stories are broadcast on a news channel or otherwise switch to another news channel.

There is therefore a need to provide viewers with the ability to select video segments based on content including content rating for both live and prerecorded broadcasts.

### SUMMARY OF THE INVENTION

The present invention overcomes the disadvantages and limitations of the prior art by providing a system which will allow a user to select preferences to either select or exclude video segments based upon content to the video segment.

The present invention may therefore comprise a method of selecting and excluding video segments in a video stream to be viewed by a viewer comprising: placing markers in the video stream that indicate the position of a division between the video segments of the video stream; placing tags in the video stream that indicate content of each video stream; using video preference information of the viewer to select and exclude video segments by comparing the tags with the video preference information of the viewer; inserting alternate video segments that replace video segments that have been excluded by the viewer.

The present invention may therefore comprise a system for selecting and excluding video segments in a video stream to be viewed by a viewer comprising: an encoder that encodes the video stream with tags and markers to generate an encoded video stream; a set-top box that receives the encoded video stream and separates the tags and the markers from the encoded video stream to generate an un-encoded video stream; a video database, coupled to the set-top box, that stores the un-encoded video stream and generates a selected video stream; a comparator, coupled to the set-top box, that receives the tags and the markers and viewer preferences and compares the tags with the viewer preferences to generate pointers, that point to locations of video segments in the video database, and that select and exclude the video segments from the video database to generate the selected video stream.

### BRIEF DESCRIPTION OF THE DRAWINGS

FIG. 1 is a block diagram that indicates the manner in which encoded video is generated.

FIG. 2 is a schematic block diagram illustrating customer (user or viewer) hardware that can be used in accordance with one embodiment for implementing the present invention.

FIG. 3 is a schematic block diagram illustrating another manner of implementing the present invention.

FIG. 4 is a schematic block diagram illustrating the manner in which video is selected in accordance with FIG. 3.

FIG. 5 is a schematic block diagram of the video segment database.

FIG. 6 is a schematic block diagram of a studio that generates live analog video and alternate video to be sent to a cable head-end.

FIG. 7 is a schematic block diagram of a cable head-end and user system that receive live analog video from the head-end in accordance with the present invention.

FIG. 8 is a schematic flow diagram of the operation of the device of FIG. 7.

FIG. 9 is a schematic block diagram of a system that uses delayed video.

FIG. 10 is a flow diagram of the device of FIG. 9.

### DETAILED DESCRIPTION OF THE INVENTION

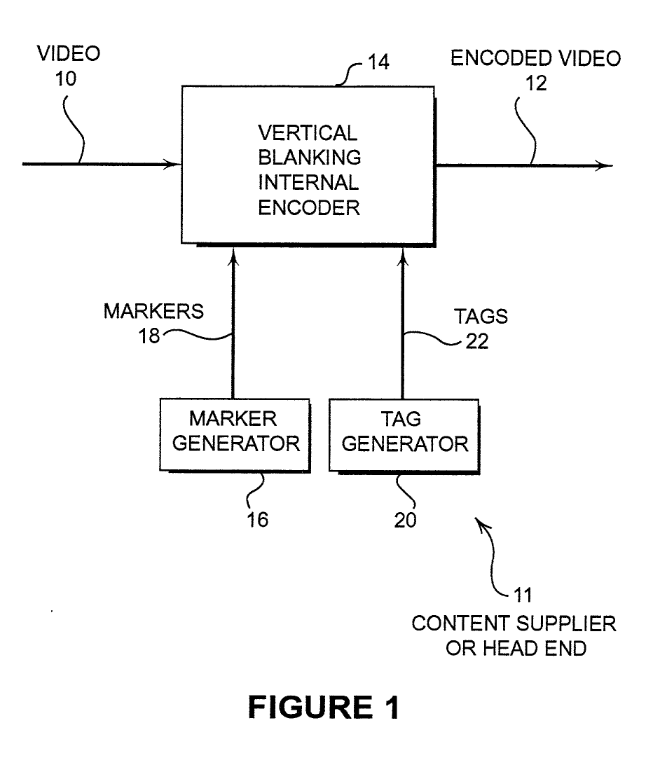

FIG. 1 discloses the manner in which video 10 can be encoded by a content supplier or head-end 11 to generate encoded video 12. As shown in FIG. 1, a vertical blanking encoder 14 is used to encode the video 10 with markers 18 and tags 22. Marker generator 16 generates markers that mark the beginning/end of each video segment. For example, in a news broadcast a video segment may pertain to a particular news story such as the crash of the Concorde jet airliner or the crash of the Russian submarine. Each of these news stories is set off by a marker to mark the end of a video segment and the beginning of the next video segment. These markers may be entered manually by the content supplier or at the head-end. Similarly, various methods of automatically inserting markers can be used such as determining sound levels, brightness or intensity readings from video, and other such methods. Of course, any desired method can be used for generating markers. Marker generator 16 can also generate markers 18 that can be inserted in various portions of a movie to identify video segments relating to violence, sex, adult language, and other types of content information that may relate to video preferences of the user. Again, these markers can be generated based upon information in the video segment such as flesh tone, voice recognition, or similar processes. Of course, these markers can also be generated manually by the content provider.

As also shown in FIG. 1, tag generator 20 generates tags 22 that are applied to the vertical blanking interval (VBI) encoder 14. Tags 22 provide information relating to the content of the video segment. For example, a news segment may be identified as “Concorde crash” or “Russian Submarine,” etc. The tags also may identify the rating of the video segment including rating information pertaining to adult content, adult language, violence, and other rating information. In addition, certain key words may be used as the tag generator such as murder, kill, shoot, or rape to exclude certain video segments. On the other hand, other key words such as stock market, Wall Street, Dow Jones, Nasdaq, interest rate, Greenspan, Cubs, White Sox, Redskins, Broncos, Avalanche, etc. can be used to select certain video segments. The tag generator 20 may obtain information from the electronic programming guide (EPG). Further, the EPG may be implemented for each video segment and include rating information plus identifiers in the form of key words for each video segment. The EPG can then be inserted in the video blanking interval in this fashion.

The vertical blanking interval (VBI) encoder 14 of FIG. 1 inserts the markers 18 and tags 22 in the vertical blanking interval that occurs during the vertical retrace. The markers 18 and tags 22 can be encoded as either analog or digital data in the video stream 10 to generate the encoded video stream 12.

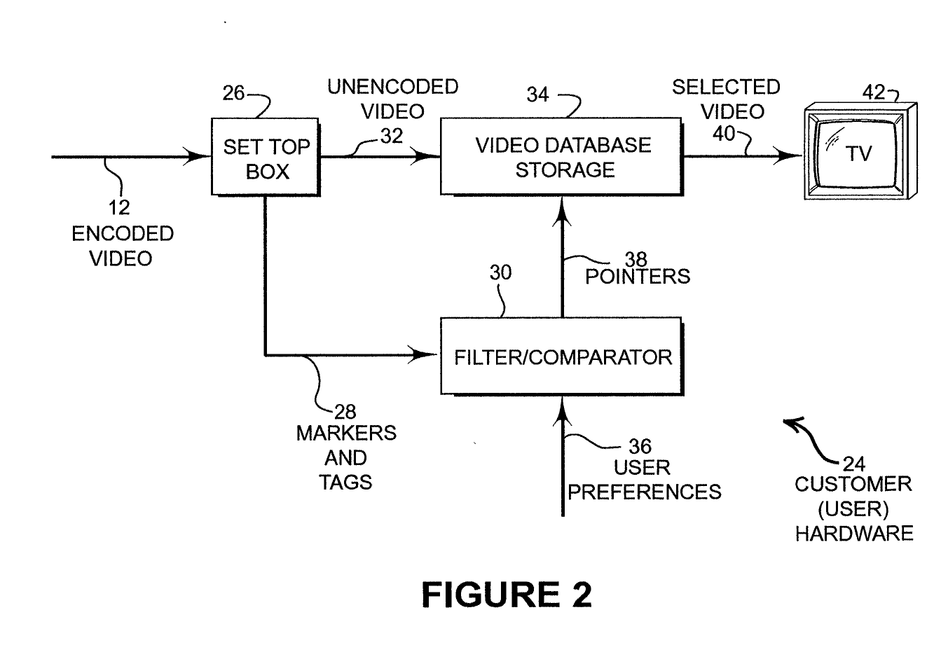

FIG. 2 is a schematic block diagram of customer (user) hardware 24 that can be used in accordance with one embodiment of the present invention with encoded video to allow selection or exclusion (de-selection) of video segments. As shown in FIG. 2, the encoded video 12 is received by the set-top box 26 at the user's premises. The set-top box includes a vertical blanking interval decoder which is built into the set-top box 26 and is capable of separating the markers and tags from the video stream. The markers and tags are separated by the built-in vertical blanking interval decoder and sent to a filter/comparator 30 by way of connector 28. The unencoded video 32 is then sent to a video database storage device 34. User preferences 36 are entered by the user into the filter comparator 30 that contains storage for storing the user preferences. As indicated above, the user preferences can be in the form of key words or rating information. The filter comparator 30 compares the user preferences with the tags and determines a particular pointer for selected video segments. The pointer 38 is then sent to the video database storage device 34. The pointer 38 is used to select a video segment from the video database storage 34. The video database storage device 34 then transmits the selected video 40 to the user's TV 42 for display. In this fashion, selected video segments can be viewed in a slightly delayed but nearly real time fashion. The system of FIG. 2 can also be used to exclude video segments by allowing the video database storage device 32 to transmit all of the video segments except those that have been excluded or de-selected using the pointers 38.

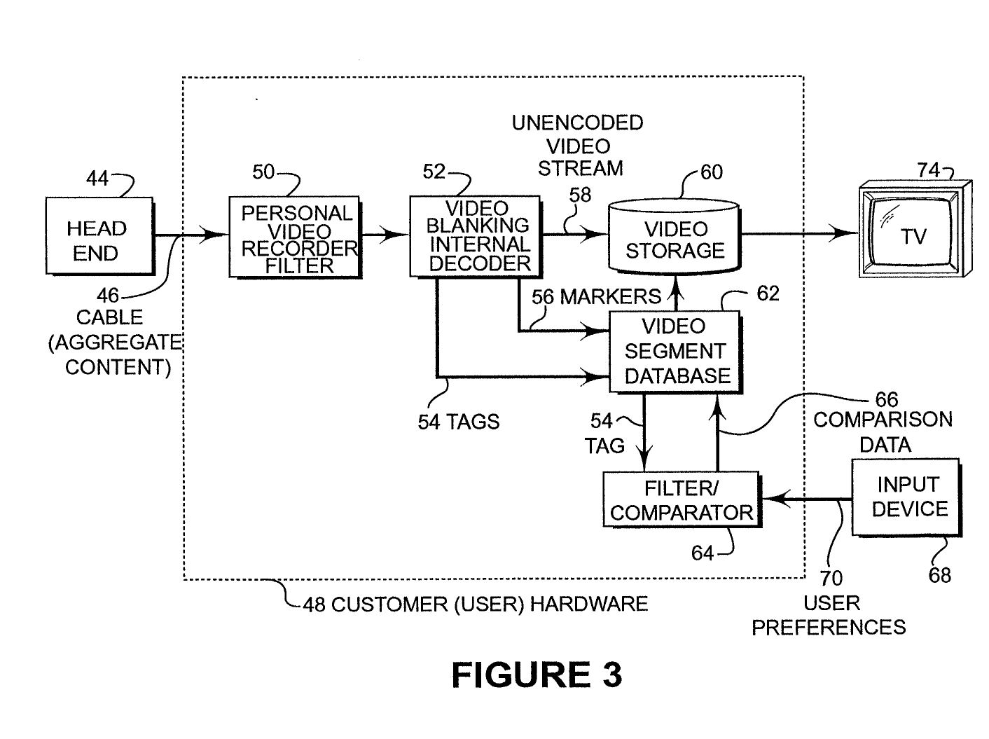

FIG. 3 is a schematic diagram of another implementation of the present invention. As shown in FIG. 3, the head-end 44 provides the aggregate content video over cable 46 to the customer (user) hardware 48 located at the user's site. The user may have a personal video recorder filter device 50 that is connected to the cable input 46 that selects certain video from the aggregate content video for recording based upon the user's habits and preferences. The personal video recorder filter may, for example, be a system such as that provided by Tivo, Inc., of Alviso, Calif., that is capable of storing numerous hours of video feed and is also capable of selecting channels and times for particular broadcasts. For example, the Tivo system may be trained to select all financial news broadcasts that are viewed by the user on particular channels at particular times. In this fashion, financial news broadcasts can be recorded by the personal video recorder filter from the aggregate content provided over the cable 46 for later downloading by the user.

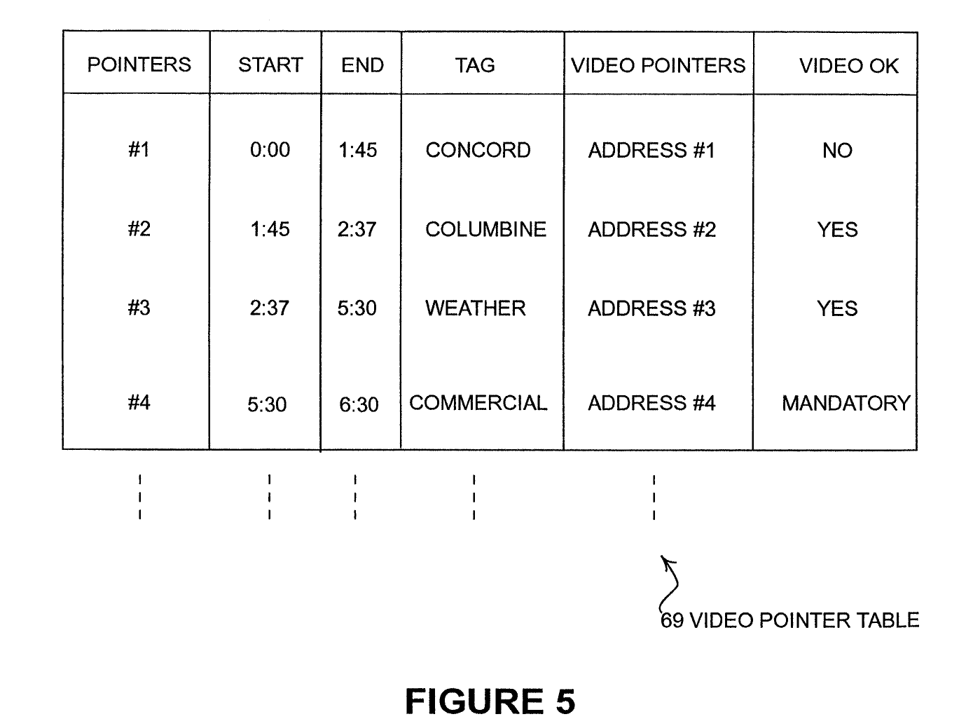

Referring again to FIG. 3, the video data that is provided by the personal video recorder filter 50 is passed to a video blanking interval decoder 52 that strips off the tags 54 and markers 56 from the video stream and provides an unencoded video stream 58. The unencoded video stream 58 is then stored in a video storage device 60. The tags and markers 56 are applied to a video segment database 62 that generates a video pointer table 64 (FIG. 5). As explained below, the video pointer table 64 identifies the address at which the particular video segment is stored in the video storage 60. The video segment database 62 generates the table that is shown in FIG. 5. The tag information 54, which forms part of the table shown in FIG. 5, is compared in a filter comparator 64 with user preferences 70 that are generated by an input device 68. The comparison data 66 is then sent back to the video segment database 62 and stored in the video pointer table 69 illustrated in FIG. 5. The data from the video pointer table 69 is then sequentially read according to the pointer number, and the information is transferred via connector 72 to the video storage 60. Video segments identified in the video pointer table 69 as being video that is OK to view are then read from the video storage device 60. The output of video storage device 60 consists of the video segments that have been authorized to be viewed by the viewer. These video segments are applied to the TV 74 for viewing by the viewer.

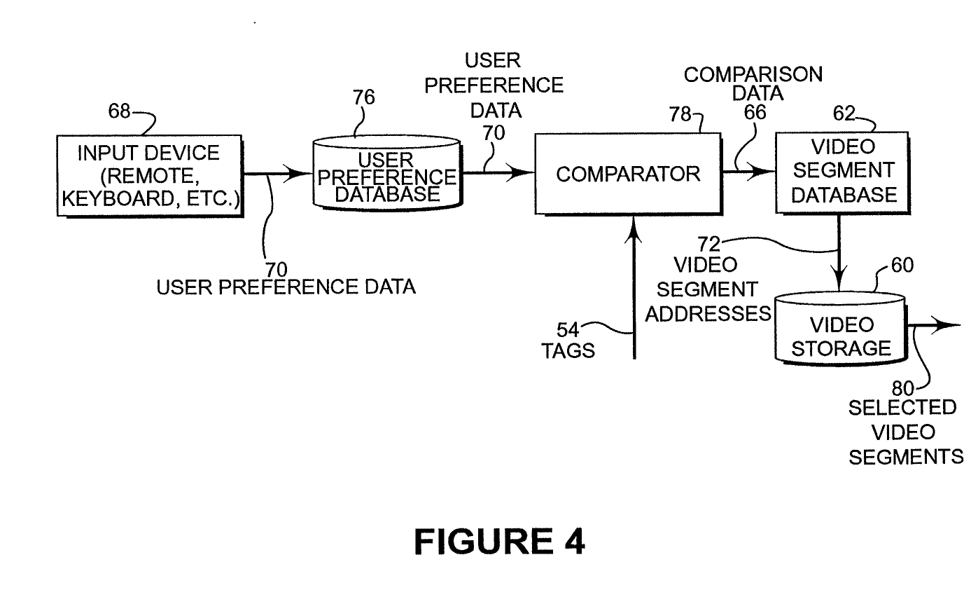

FIG. 4 is a more detailed block diagram illustrating the manner in which video segments are selected in accordance with FIG. 3. As illustrated in FIG. 4, the user activates an input device 68 that can comprise any desired type of input device such as a remote control, a keyboard, a voice recognition circuit, or other device for generating user preference data 70. The user preference data 70 is transferred to a user preference database 76 that comprises a portion of the filter/comparator 64 (FIG. 3). The user preference data 70 is then applied to comparator 78 which is compared with the tags 54 to generate comparison data 66 that indicates whether the video segment is OK or not OK to view. This data is then sent to the video segment database 62 where it is stored in the video pointer table 69 (FIG. 5). The video pointer table 69 is then read sequentially from the video segment database 62. Video segment addresses 72 correspond to video that is OK to be viewed or sent via connector 72 to the video storage 60. Video storage 60 sequentially reads the video segments at the indicated video segment addresses to generate a sequential series of selected video segments 80.

FIG. 5 illustrates the video pointer table 69 that is stored in the video segment database 62. As shown in FIG. 5, the video pointer table 69 includes a set of pointers, a start and end time for each video segment, one or more tags that are associated with the video segment, a video pointer that indicates the address as to where the video is stored in a video storage device 60, and the comparison data indicating whether the video is OK to view. As indicated for the pointer # 1, this video segment starts at time 0 and ends at 1 minute 45 seconds. This video segment relates to the crash of the Concorde jet and is stored at address # 1 in the video storage device 60. The comparison data 66 indicates that this video clip is not OK to view by the user. This can occur either from favorable or unfavorable comparisons with the user preference data depending on the system's selection preferences or exclusion preferences.

As also indicated in FIG. 5, the viewer would like to view video clips regarding the Russian submarine crash and the weather. The commercial video segment is indicated as a mandatory video segment that cannot be excluded from the selected video segments 80 (FIG. 4).

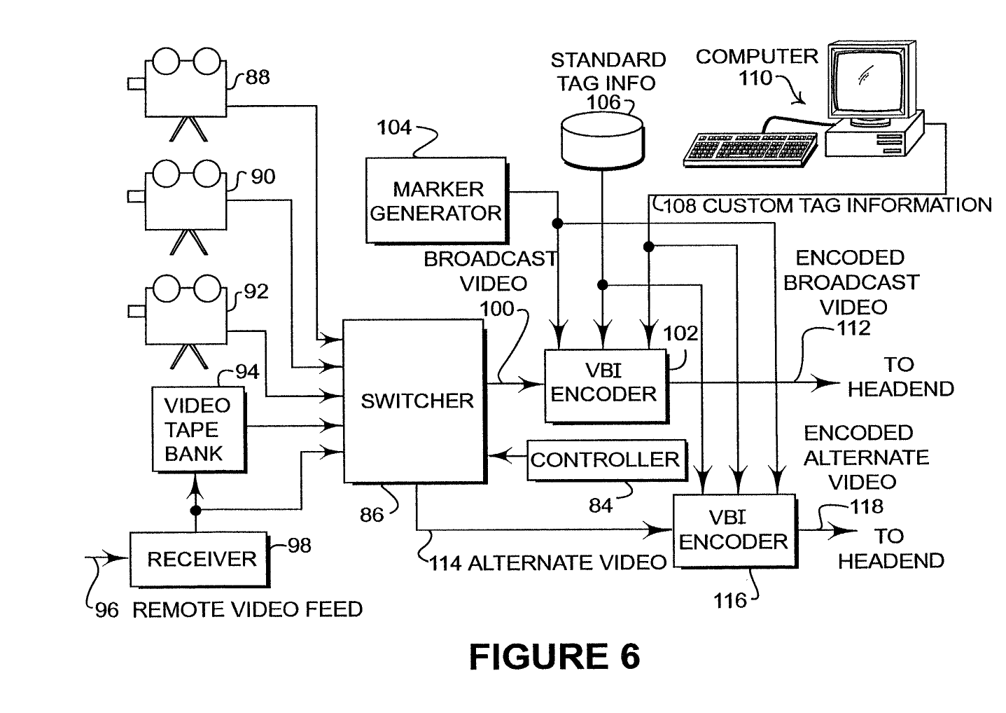

FIG. 6 is a schematic block diagram of a studio 82 that is capable of generating both regular broadcast video and alternate video feeds. Alternate video feeds can be used as substitute video feeds if a particular video segment from the regular broadcast has been excluded (de-selected) by the user. As shown in FIG. 6, a controller 84 generates control signals that are applied to switcher 86 to control the switcher 86. Switcher 86 selects one of a number of different video feeds including feeds from studio cameras 88, 90, and 92, a video tape bank 94, or a remote video feed 96 that has been received by a receiver 98 from a remote source. The output of the switcher 86 is the broadcast video signal 100. The broadcast video signal 100 is applied to a video blanking interval encoder 102 that encodes the broadcast video signal 100 with marker and tag information. Marker generator 104 generates the markers that indicate the beginning/end of each video segment. As indicated above, these may be generated manually in the studio or automated methods of generating markers may be used by the marker generator 104. Additionally, tag information is encoded on the broadcast video signal by the VBI encoder 102. Standard tag information such as “weather,” “commercial,” etc. is stored in the storage device 106 and applied to the VBI encoder for the appropriate video segment. Additionally, custom tag information 108 can be generated by computer 110 and applied to the VBI encoder 102. Custom tag information can be entered manually through the computer 110, or other means of generating the custom tag information can be used such as voice recognition and other methods disclosed above. The VBI encoder 102 then generates an encoded broadcast video signal 112 that is sent to the head-end. Switcher 86 can also generate an alternate video signal 114 that comprises an alternate selection of video that can be used to replace excluded video segments during a real time broadcast. The alternate video 114 is applied to a video blanking interval encoder 116 that is connected to a marker generator 104, a standard tag information generator 106, and computer 110 that generates custom tags information 108. The VBI encoder 116 generates an encoded alternate video signal 118 that is sent to the head-end.

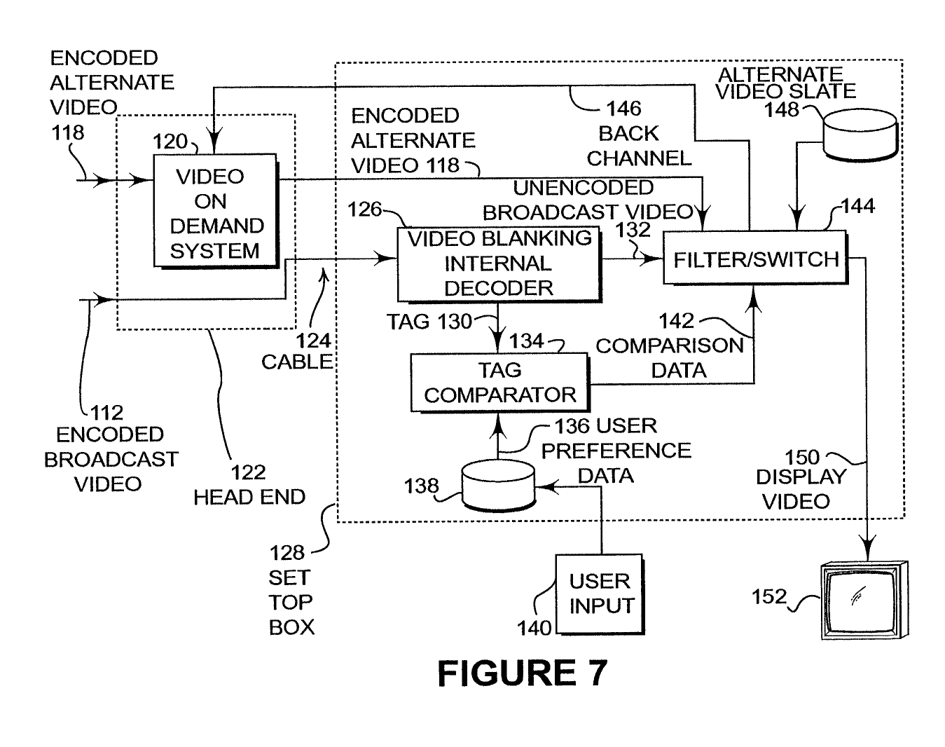

FIG. 7 illustrates the manner in which the encoded alternate video signal 118 and encoded broadcast video signal 112 are applied to the head-end and then transferred to the user's premises. As shown in FIG. 7, the encoded alternate video signal 118 is applied to a video-on-demand system 120 that is operated by the head-end 122. The encoded broadcast video signal 112 is handled and processed in the same manner by the head-end as any standard broadcast signal. The cable system 124 delivers the encoded broadcast video signal 112 and the encoded alternate video signal 118 to the set-top box 128 at the user's premises. The encoded broadcast video signal 112 is applied to a video blanking interval decoder 126 that decodes the encoded broadcast video to separate the tag information 130 from the unencoded broadcast video 132. The tags are sent to a tag comparator 134 which compares the tag information with user preference data 136. The user preference data 126 is stored in a storage device 138 in the set-top box 128. The user can insert the user preference data 136 into the storage device by way of a user input 140 in the manner described above. The tag comparator 134 generates comparison data 142 that is applied to the filter/switch 144. The filter/switch uses the comparison data 142 to either select or de-select the unencoded broadcast video signal 132. If it is determined by the tag comparator 134 that the video segment should not be shown, a signal can be generated by the filter/switch 144 on back channel 146 to activate the video-on-demand system 120 to generate the encoded alternate video 118 that is applied to the filter/switch 144. The back channel can comprise an asymmetric type system that uses standard telecommunications connections or can be connected back to the head-end 122 through the cable system. Alternately, the filter/switch can select a video slate from the alternate video slate storage device 148. The alternate video slate may comprise a slate such as a screen saver, commercial banner advertisement or other type of standard display. The output of the filter/switch 144 is the display video 150 that is applied to the user's television 152 for display.

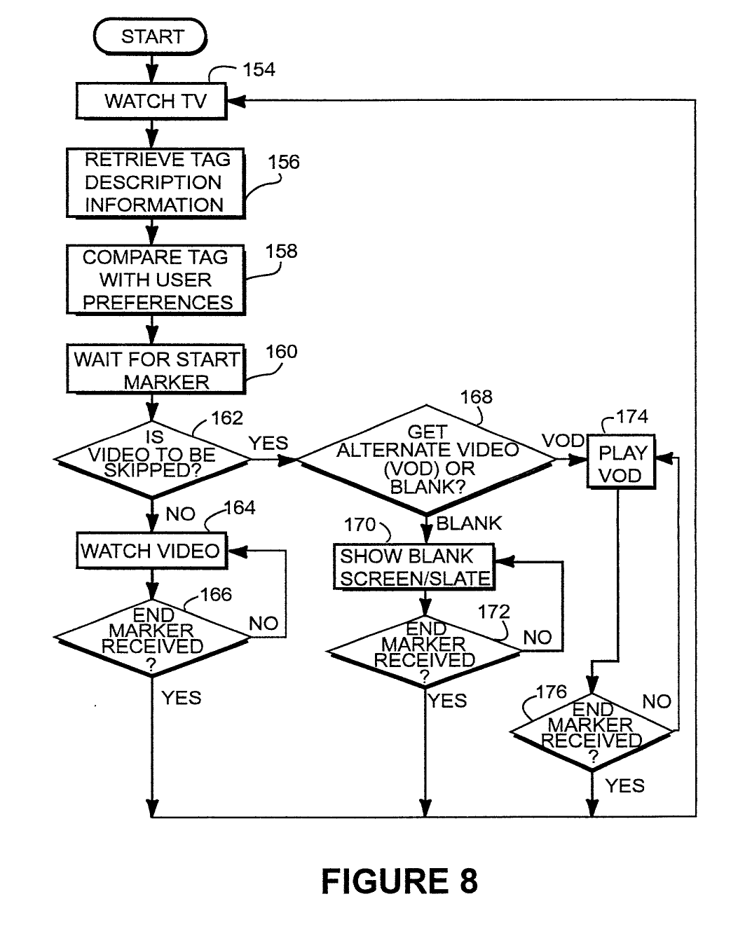

FIG. 8 is a schematic flow diagram of the steps that are performed by the system of FIG. 7. As shown in FIG. 8, the user is watching TV at step 154. At step 156, the tag description information is retrieved from the encoded broadcast video by the video blanking interval decoder 126. The tag information is then compared with the user preferences by the tag comparator 134 at step 158. The system then waits for the start marker (first marker) at step 160. A decision is then made at step 162 as to whether the video segment is to be skipped. If it is not, the video is viewed at step 164. A decision is then made at step 166 as to whether the marker is the last marker. If it is the last marker, the process returns to step 154. If it was not the last marker, the process returns to step 164 and waits for the last marker.

Returning to step 162 of FIG. 8, if it is determined that the video should be skipped a decision is made to go to step 168 to obtain the alternate video, such as the video-on-demand, a blank screen, or slate. If it is determined that a blank screen or a slate should be displayed, the process proceeds to step 170 to show the blank screen or slate. A decision is then made at step 172 as to whether the latest marker is the last marker. If it is, the process returns to step 154. If it is not, the process returns to step 170 and continues to show the blank screen or slate. Returning to step 168, if it is determined to obtain the video-on-demand, the process proceeds to step 174 to play the video-on-demand. It is then determined whether the end marker has been received at step 176. If it has not, the process returns to step 174. If the end marker has been received, the process returns to step 154.

The process steps illustrated in FIG. 8 are one example of the manner in which this invention can be carried out. The processes described with regard to FIGS. 6 and 7 constitute alternative ways of carrying out the invention.

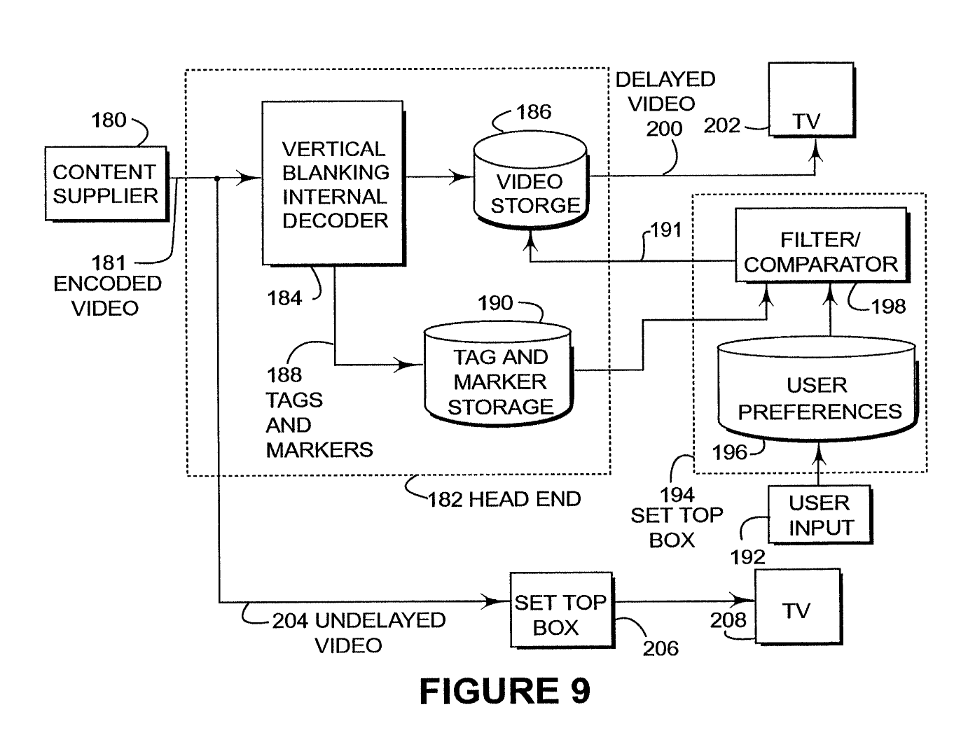

FIG. 9 is a schematic block diagram illustrating another method of implementing the present invention. Content supplier 180 supplies encoded video 181 to the head-end device 182. The encoded video 181 includes tags and markers that have been inserted in the video blanking interval by the content provider. The encoded video is sent to a video blanking interval decoder 184 at the head-end 182. The video blanking encoder 184 separates the video stream, which is sent to video storage 186, from the tags and markers 188, which are sent to the tags and markers storage device 190. The tags and markers storage device 190 stores the tags and markers 188 that have been separated from the encoded video signal. The user input 192 is used to generate user preferences that are applied by the user to the set-top box 194. The set-top box has a storage device 196 that stores the user preferences. The filter comparator 198 compares the tags with the user preference data and uses the markers to identify video segments that have been authorized to be viewed. This information is sent to the video storage device 186. Video storage device 186 reads the video segments that have been authorized from the data storage locations that have been identified from the output of the filter/comparator 198. The video storage device 186 therefore generates a delayed video stream 200 that is displayed on the TV 202. FIG. 9 also illustrates the manner in which the system can be implemented in a manner that by-passes certain features of the present invention. For example, the undelayed video 204 can be sent from the head-end 182 directly to the customer's premises as it is conventionally done by the head-end 182. As shown in FIG. 9, the undelayed video 204 is sent to set-top box 206 which displays the video on a TV 208.

Referring again to FIG. 9, another method of operating the system can be implemented. The user can be allowed to sequentially view each of the video segments and use the user input device 192 to switch from one segment to another sequentially by skipping to the next marker. These input control signals, that are supplied through the user input 192, instruct the video storage device 186 to skip to the next marker and supply the TV 202 with the next video segment.

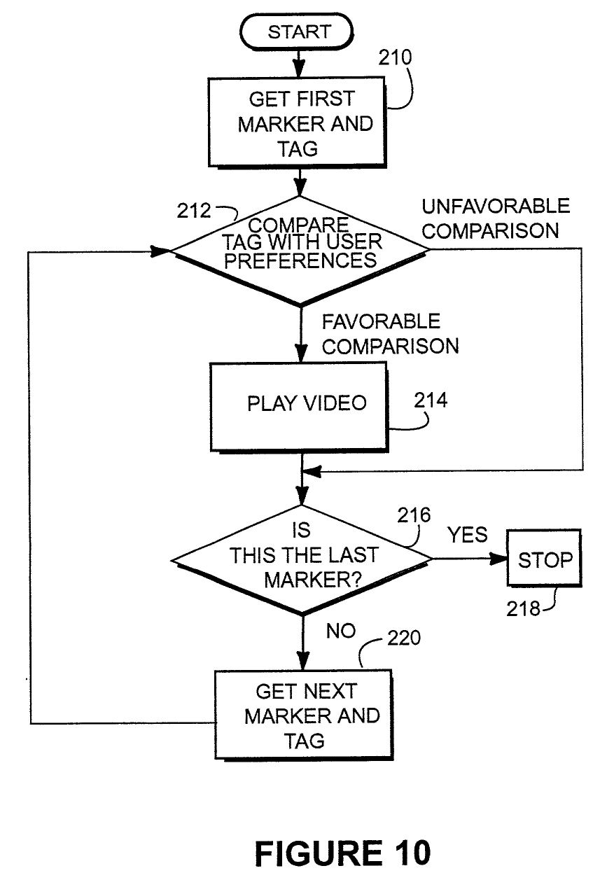

FIG. 10 is a schematic flow diagram illustrating the process steps that can be carried out by the present invention. As shown in FIG. 10, the process starts by obtaining the first marker and tag at step 210. At step 212, the tag is compared with the user preferences. If there is a favorable comparison, the video segment is played at step 214. It is then determined whether the last marker has been read at step 216. If there is an unfavorable comparison at step 212, the process skips directly to step 216. If this is the last marker, then the process stops at step 218. If it is not the last marker, the next marker and tag are retrieved at step 220. The process then returns to step 212.

The present invention therefore provides a system for viewing selected video segments and excluding video segments that do not correspond to user preferences. This allows the user to exclude certain video segments or select certain video segments from selected programming. The system can use rating information and tags that can be generated either manually or automatically. Further, the user can skip from one video segment to the next by implementing the system to skip to the next marker in response to a user input. All of these functions allow the user to maximize preferred content for a given video viewing segment.

What is claimed is:

1. A method of selecting and excluding video segments in a video stream to be viewed by a viewer comprising:
placing markers in said video stream that indicate the position of a division between said video segments of said video stream;
placing tags in said video stream that indicate content of each video segment;
using video preference information of said viewer to select and exclude video segments by comparing said tags with said video preference information of said viewer;
inserting alternate video segments that replace video segments that have been excluded by said viewer.

2. The method of claim 1 wherein said step of placing tags within said video stream comprises placing key words, within said video stream, relating to the content of said video stream and comparing said key words with said preference information to select and exclude video segments.

3. The method of claim 1 wherein the step of placing tags within said video stream comprises placing tags manually by use of a computer within said video stream.

4. The method of claim 1 wherein the step of placing tags within said video stream comprises placing tags automatically by use of voice recognition techniques that indicate said content of said video stream.

5. The method of claim 1 wherein said step of placing markers within said video stream comprises automatically placing markers in said video stream based upon change of scenes.

6. The method of claim 1 wherein said step of selecting and excluding said video segments within said video stream comprises comparing key words that are input by said viewer with key words that have been placed within said video stream.

7. The method of claim 1 wherein said step of placing tags within said video stream comprises placing information from an Electronic Programming Guide into said video stream.

8. The method of claim 1 wherein said step of placing said tags into said video stream further comprises placing said tags in a vertical blanking interval within said video stream.

9. The method of claim 1 wherein said step of placing said markers into said video stream further comprises placing said markers in a vertical blanking interval within said video stream.

10. The method of claim 1 wherein said step of excluding said video segments comprises eliminating said excluded video segment in said video stream and proceeding to a selected video segment.

11. The method of claim 1 wherein said step of excluding said video segments comprises selecting said alternate video that replaces said excluded video segment.

12. The method of claim 1 wherein said step of excluding said video segments further comprises displaying a blank slate during an excluded video segment.

13. The method of claim 1 wherein said step of selecting and excluding video segments in a video stream further comprises selecting and excluding video segments in video games.

14. A method of excluding video segments in a video stream to be viewed by a viewer comprising:
placing markers in said video stream that indicate the position of a division between said video segments of said video stream;
placing tags in said video stream that indicate content of each video stream;
using video preference information of said viewer to exclude video segments by comparing said tags with said video preference information of said viewer;
inserting alternate video segments that replace video segments that have been excluded by said viewer.

15. A method of selecting and excluding video segments in a video stream to be viewed by a viewer comprising:
placing markers in said video stream that indicate the position of a division between said video segments of said video stream;
placing tags in said video stream that indicate content of each video stream;
storing said video content at said viewer's premises in local storage;
using video preference information of said viewer to select and exclude video segments by comparing said tags with said video preference information of said viewer;
downloading said selected video segments from said video content stored in said local storage for viewing by said viewer.

16. A method of selecting and excluding video segments in a video stream to be viewed by a viewer comprising:
placing markers in said video stream that indicate the position of a division between said video segments of said video stream;
placing tags in said video stream that indicate content of each video stream;
using video preference information of said viewer to select and exclude video segments by comparing said tags with said video preference information of said viewer;
placing key words within said video stream that relate to the content of said video stream and comparing said key words with said preference information to select and exclude video segments.

17. A method of selecting video segments in a video stream to be viewed by a viewer comprising:
placing markers in said video stream that indicate a the position of a division between said video segments of said video stream;
placing tags in said video stream that indicate content of each video stream;
using video preference information of said viewer to select video segments by comparing said tags with said video preference information of said viewer;
placing key words within said video stream that relate to the content of said video stream and comparing said key words with said preference information to select video segments.

18. A method of excluding video segments in a video stream to be viewed by a viewer comprising:
placing markers in said video stream that indicate the position of a division between said video segments of said video stream;
placing tags in said video stream that indicate content of each video stream;
using video preference information of said viewer to exclude video segments by comparing said tags with said video preference information of said viewer;
placing key words within said video stream that relate to the content of said video stream and comparing said key words with said preference information to exclude video segments.

19. A system for selecting and excluding video segments in a video stream to be viewed by a viewer comprising:
an encoder that encodes said video stream with tags and markers to generate an encoded video stream;
a set-top box that receives said encoded video stream and separates said tags and said markers from said encoded video stream to generate an un-encoded video stream;
a video database, coupled to said set-top box, that stores said un-encoded video stream and generates a selected video stream;
a comparator, coupled to said set-top box, that receives said tags and said markers and viewer preferences and compares said tags with said viewer preferences to generate pointers, that point to locations of video segments in said video database, and that select and exclude said video segments from said video database to generate said selected video stream.

20. The system of claim 19 further comprising:
a personal video recorder coupled to an input of said set-top box that filters said video stream to provide said video segments to be viewed by said viewer.

21. The system of claim 21 wherein said set-top box further comprises:
a video blanking interval decoder that separates said tags and said markers from said encoded video stream.

22. The system of claim 19 wherein said set-top box further comprises:
a filter/switch that uses comparison data to select and exclude said un encoded video stream.

23. The system of claim 19 wherein said tags comprise content data relating to said video segment.

24. The system of claim 19 wherein said tags comprise rating information of said video segment.

25. The system of claim 19 wherein said markers are encoded as analog data in said video stream to generate said encoded video stream.

26. The system of claim 19 wherein said markers are encoded as digital data in said video stream to generate said encoded video stream.

27. The system of claim 19 wherein said tags are encoded as analog data in said video stream to generate said encoded video stream.

28. The method of claim 19 wherein said tags are encoded as digital data in said video stream to generate said encoded video stream.

29. The system of claim 19 wherein said markers are inserted into said video stream to indicate the division between video segments by changes in flesh tone within said video stream.

30. The system of claim 19 wherein said markers are inserted into said video stream to indicate the division between video segments by changes in audio levels within said video stream.

31. The system of claim 19 wherein said markers are inserted into said video stream to indicate the division between video segments by changes in light levels within said video stream.

32. The system of claim 19 wherein said markers are inserted into said video stream to indicate the division between video segments by changes in color within said video stream.

33. The system of claim 19 wherein said markers are inserted into said video stream to indicate the division between video segments by applying voice recognition software to said video stream.

34. The system of claim 19 wherein said markers are inserted into said video stream to indicate the division between video segments by changes in music within said video stream.

35. The system of claim 19 wherein said markers are inserted into said video stream to indicate the division between video segments by changes in scenery within said video stream.

36. The system of claim 19 wherein said video segments in said video stream comprise a real-time signal that is sent to said set-top box at a viewer's premises.

37. The system of claim 19 wherein said video segments in said video stream comprise a delayed signal that sent to said set-top box at a viewer's premises.

38. The system of claim 19 further comprising a viewer personalized remote control that transmits said video preference information to said system and receives information from said system.

39. A system for selecting and excluding video segments in a video stream to be viewed by a viewer comprising:
a personal video recorder coupled to an input of said set-top box that filters said video stream to provide said video segments to be viewed by said viewer;
an encoder that encodes said video stream with tags and markers to generate an encoded video stream;
a set-top box that receives said encoded video stream and separates said tags and said markers from said encoded video stream to generate an un-encoded video stream;
a video database, coupled to said set-top box, that stores said un-encoded video stream and generates a selected video stream;
a comparator, coupled to said set-top box, that receives said tags and said markers and viewer preferences and compares said tags with said viewer preferences to generate pointers, that point to locations of video segments in said video database, and that select and exclude said video segments from said video database to generate said selected video stream.

40. The system of claim 39 wherein said comparator selects video segments in a video stream to be viewed by a viewer.

41. The system of claim 39 wherein said comparator excludes video segments in a video stream to be viewed by a viewer.

42. A system for selecting one of an encoded regular broadcast video stream and an encoded alternate video stream comprising:
a video blanking interval decoder that separates said tags and said markers from said encoded regular broadcast video stream;
a comparator, coupled to said video blanking interval decoder, that receives said tags and said markers and viewer preferences and compares said tags with said viewer preferences to select and exclude said video segments;
a storage device, coupled to said comparator, that stores said viewer preferences of said viewer;
a filter/switch, coupled to said comparator and said video blanking interval decoder, that uses comparison data to generate a request signal for said alternate video segments;
a video-on-demand system, located at a headend, that receives said request signal for said alternate video segments and sends said alternate video segments to said filter/switch.

43. The system of claim 42 further comprising a video content provider that generates said regular broadcast video stream and said alternate video stream comprising:
a video stream source that generates multiple video sources;
a controller that generates control signals;
a switcher, coupled to said controller, that receives said control signals from said controller and generates said broadcast video stream and said alternate video stream.

44. The system of claim 43 wherein said video stream source comprises studio cameras that generate video streams.

45. The system of claim 43 wherein said video stream source comprises a video tape bank.

46. The system of claim 43 wherein said video stream source comprises a receiver that receives a remote video stream from a remote source.

47. The system of claim 43 further comprising:
a marker generator that generates markers;
a computer that generates custom tag information;
voice recognition software, coupled to said computer, that generates said custom tag information;
a remote control that generates said custom tag information;
a keyboard that generates said custom tag information;
tag storage that stores said custom tag information.

48. The system of claim 47 further comprising:
a video blanking interval encoder, coupled to said marker generator and said computer and said remote control and said keyboard and said voice recognition software and said tag storage, that receives said markers and said tags and said broadcast video stream and said alternate video stream from said switcher, and that encodes said broadcast video stream and said alternate video stream with said markers and said tags to generate an encoded broadcast video stream and an encoded alternate video stream that are sent to a headend.

49. The system of claim 43, wherein said alternate video stream comprises an alternate selection of video that replaces excluded video segments.

50. The system of claim 42 further comprising an alternate video slate generator, coupled to said filter/switch, that generates an alternate video slate signal that is applied to said filter/switch.

51. The system of claim 42 wherein a back channel transmits said request signal for said alternate video segments.

52. The system of claim 50 wherein said alternate video slate signal comprises a screen saver.

53. The system of claim 50 wherein said alternate video slate signal comprises wall paper.

54. The system of claim 50 wherein said alternate video slate signal comprises advertisements.

55. The system of claim 50 wherein said alternate video slate signal comprises standard displays.

56. The system of claim 51 wherein said back channel comprises an asymmetric system that uses standard telecommunications connections.

57. The system of claim 50 wherein said back channel comprises a cable.

58. The system of claim 42 further comprising a television monitor, coupled to said filter/switch, that receives said video segments from said filter/switch and displays said video segments.

59. The system of claim 42 wherein said comparator selects video segments in a video stream to be viewed by a viewer.

60. The system of claim 42 wherein said comparator excludes video segments in a video stream.

61. A method of selecting and excluding video segments in a video stream to be viewed by a viewer comprising:
placing markers in said video stream that indicate the position of a division between said video segments of said video stream;
placing tags in said video stream that indicate content of each video stream;
using video preference information of said viewer to select and exclude video segments by comparing said tags with said video preference information of said viewer;
inserting alternate video segments that have been selected by said viewer to replace video segments that have been excluded by said viewer.

62. The method of claim 61 wherein said step of inserting said viewer preferences comprises inserting key words that are entered by said viewer that are compared to said tags to select and exclude said video segments.
